(19) United States
(12) Patent Application Publication
(10) Pub. No.: US 2020/0249702 A1
(43) Pub. Date: Aug. 6, 2020

(54) SYSTEM AND METHOD FOR WIND TUNNEL TESTING A UAS IN A FULLY AUTONOMOUS OPERATING MODE

(71) Applicant: NUAIR Alliance, Syracuse, NY (US)

(72) Inventor: Andrew Thurling, Fayetteville, NY (US)

(21) Appl. No.: 16/781,153

(22) Filed: Feb. 4, 2020

Related U.S. Application Data
(60) Provisional application No. 62/801,302, filed on Feb. 5, 2019.

(51) Int. Cl. G05D 1/10; G01M 9/04; G01S 19/40; B64C 39/02

(52) U.S. Cl. CPC G05D 1/1062; G01M 9/04; B64C 2201/145; B64C 39/024; G01S 19/40

(57) ABSTRACT

A method for testing a UAS in a fully autonomous operating mode includes: providing an unmanned aerial system (UAS), the UAS having a range of flight motion in a flyable airspace within a wind tunnel; flying the UAS in a space in the wind tunnel to achieve a simulated flight over a route longer than any physical extent of the flyable airspace of the wind tunnel; advancing a simulated position transmitted by the GPS simulator; measuring an actual position of the UAS; and adjusting the advancing simulated position to reflect the actual position of the UAS; and repeating the step of flying to the step of adjusting for a duration of the simulated flight. A system for testing a UAS in a fully autonomous operating mode is also described.

### CROSS-REFERENCE TO RELATED APPLICATIONS

This application claims priority to and the benefit of co-pending U.S. provisional patent application Ser. No. 62/801,302, SYSTEM AND METHOD FOR WIND TUNNEL TESTING A UAS IN A FULLY AUTONOMOUS OPERATING MODE, filed Feb. 5, 2019, which application is incorporated herein by reference in its entirety.

### FIELD OF THE APPLICATION

The application relates to wind tunnel testing, particularly to wind tunnel flight testing of UAS.

### BACKGROUND

Weather and winds, thermals and turbulence pose an ever-present challenge to small Unmanned Aerial Systems (UAS). UAS are understood hereinbelow as synonymous with unmanned aerial vehicles (UAV).

### SUMMARY

A method for testing a UAS in a fully autonomous operating mode includes: providing an unmanned aerial system (UAS) with an onboard GPS navigation system, the UAS having a range of flight motion in a flyable airspace within a wind tunnel, a GPS simulator operatively coupled to at least one processor, and a UAS position locating apparatus operatively coupled to the GPS simulator; flying the UAS in a space in the wind tunnel to achieve a simulated flight over a route longer than any physical extent of the flyable airspace of the wind tunnel; advancing by the at least one processor, a simulated position transmitted by the GPS simulator during the simulated flight; measuring by the UAS position locating apparatus, an actual position of the UAS substantially in real time; and adjusting substantially in real time the advancing simulated position to reflect the actual position of the UAS in the flyable airspace of the wind tunnel; and repeating the step of flying to the step of adjusting for a duration of the simulated flight.

The step of flying can include a perturbation within the flyable airspace of the wind tunnel which causes the actual position of the UAS to deviate from a simulated position based on time of flight.

The perturbation can be caused by an intentional upset to an airflow within the wind tunnel.

The intentional upset to the airflow within the wind tunnel can include a simulated wind gust.

The simulated wind gust can include an updraft or a downdraft. The simulated wind gust can include a microburst. The simulated wind gust can include a voracity.

The perturbation can be caused by an intentional upset command to a flight control of the UAS. The perturbation can include an upset in roll or pitch of the UAS. The perturbation can include an upset in yaw of the UAS. The perturbation can include an upset in at least one power plant motor or engine. The perturbation can include an upset in at least one propeller or fan.

A system for testing a UAS in a fully autonomous operating mode includes a wind tunnel having a flyable airspace disposed within. The wind tunnel is adapted for a flight of an unmanned aerial system (UAS) with an onboard GPS navigation system. The UAS has a range of flight motion in the flyable airspace within the wind tunnel. A GPS simulator is operatively coupled to at least one processor. A UAS position locating apparatus to determine the actual position of the UAS in the flyable airspace is operatively coupled to the GPS simulator.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a drawing showing a comparison of 3,000-meter HRRR and 1,000-meter resolution AceCAST™;

FIG. 2 is a drawing showing training data from Synthetic LIDAR images and Computational Fluid Dynamics Winds;

FIG. 3 is a drawing showing an exemplary translation of weather Information into actionable information;

FIG. 4 is a table showing notional mission task elements (MTE) for UAS disturbance rejection;

FIG. 5 is a drawing showing an exemplary Windshape “Wind Pixel”;

FIG. 6 is a drawings showing exemplary MTE;

FIG. 7 is a drawings showing an exemplary WindShape facility at Caltech;

FIG. 8A is a drawing showing motion-induced relative wind testing;

FIG. 8B is a drawing showing descent testing;

FIG. 8C is a drawing showing testing in turbulent wind environments;

FIG. 8D is a drawing showing testing in arbitrary combinations of wind and motion;

FIG. 9 is a drawing showing a free-flying drone tracked by motion capture cameras while gusts are being generated by a WindShaper with associated graphs;

FIG. 10 is a drawing showing rain testing of a drone in an existing WindShape facility;

FIG. 11 is a drawing showing an exemplary testing session of a commercial drone in an existing WindShape facility;

FIG. 12A is a drawing showing Testing of swarm resilience to turbulent winds (for drone shows, for instance);

FIG. 12B is a drawing showing Testing of obstacle avoidance capability;

FIG. 12C is a drawing showing Testing the effect of a time-varying gust induced by a travelling vehicle;

FIG. 12D is a drawing showing Weather (rain, snow, hail, dust etc.) testing;

FIG. 13 is a drawing showing exemplary drone position and behavior captured during an indoor flight;

FIG. 14 is a drawing showing an exemplary decomposition into MTEs from Larger Atmospheric Structures;

FIG. 15A is a drawing showing a system according to the application. FIG. 15B is another drawing showing a system according to the application.

FIG. 16 is a drawing showing an exemplary camera placement;

FIG. 17 is a drawing showing a cutaway view of the a WindEEE facility at Western University;

FIG. 18 is a drawing showing a UAV in the WindEEE facility;

FIG. 19 is a graph showing a time series of a down burst coupled with the Atmospheric Turbulent Boundary Layer;

FIG. 20 is a drawing showing a drone being exposed to the wind time series of FIG. 19;

FIG. 21 is a drawing showing an exemplary positioning of WindShape elements in a WindEEE facility:

FIG. 22 is a drawing showing how an airflow from the WindEEE wind tunnel can create the “steady state” flow; and

FIG. 23 is a flow diagram showing an exemplary method according to the application.

### DETAILED DESCRIPTION

### Definitions

Wind tunnel—As used hereinbelow, wind tunnel refers to any test space having a flyable airspace for a UAS under test. Typically, but not necessarily, there is a controllable flow of air through the flyable airspace. Typically, the controllable flow of air through the airspace provides an airspeed (e.g. indicated air speed) even when the UAS is not moving within the flyable airspace. For example, a UAS hovering in a wind tunnel can still be made to simulate motion over the ground, such as from a point A to a point B. Typically, such point A to point B simulated motion is a direct ground path. However, the flyable airspace is typically a three-dimensional volume (3D) and therefore actual flight paths can be represented as flight vectors, such as where there is a change in altitude. Or, there can be complex motions including any combination of roll, pitch, and yaw of the UAS. Current suitable UAS wind tunnels include room, office, building, or warehouse spaces with one or more walls of fans. In many cases individual fans or individual groups of fans are independently controllable to create defined winds, gusts, vortices, etc. There can also be “walls” or panels of fans in the floor and/or ceiling.

GPS location—GPS location is understood to include any suitable navigation system directed by one or typically a plurality of navigation transmitters. Most common is the GPS constellation of navigation satellites. Other satellite navigation systems understood to be substantially interchangeable for this Application include, for example, GNSS, Naystar, GLONASS, BeiDow, Galileo, etc. While unusual for small UAS (e.g. a small “drone”) to have other conventional aircraft navigation receivers, it is possible that other legacy aircraft navigation systems can similarly be used, such as, for example, VOR, VORTAC, TACAN, ILS, etc.

Simulated position—For a basic path from point A to point B at substantially constant altitude, point A and point B are each different points along a simulated ground path, where the distance between point A and point B (ground path) is equal to the flight path distance. However, some UAS dynamic flight testing includes vector paths in 3D, such as, for example, from a highest altitude at one corner or a flyable airspace to a lowest altitude in another corner of the flyable airspace. While there are still different corresponding ground points (both actual ground path in the flyable airspace, and simulated world ground path) from point A to point B, the “2D” ground path can be (as in the example) less than, and not the same as, the distance of the flight path along the actual 3D flight vector.

Weather and winds, thermals and turbulence pose an ever-present challenge to Unmanned Aerial Systems (UAS), particularly small UAS. UAS are understood hereinbelow as synonymous with unmanned aerial vehicles (UAV).

Weather and winds, thermals and turbulence pose an ever-present challenge to small Unmanned Aerial Systems (UAS). These challenges become more relevant in rough terrain and especially within urban city canyons. It is currently up to pilots and operators to determine the risk weather hazards pose to flight safety. Under current Visual Line of Sight (VLOS) rules, this is not especially difficult. The old “finger in the wind” approach often gives all the data needed to make solid aviation decisions. However, as we move to Beyond VLOS (BVLOS) to operations that are increasingly more “connected”, and the human decision maker is removed both from the in-situ environment and from one-to-one responsibility for the safety of the air vehicles under his or her control, better weather at increasingly small scales becomes vital to preserving the safety of the National Airspace System (NAS).

In order to provide decision quality weather information to the UAS pilot or operator, two important pieces of the puzzle should be considered. First, as mentioned above, better prediction capabilities at much smaller scale are required. However, this only goes so far. The pilot or operator needs to understand the effects of weather on the particular UAS for which they are responsible. Weather forecasting must support sub-regional domains with terrain-influenced wind and weather data sets and for longer duration flights along the planned route of flight with more granular, high density real-time weather updates during flight execution.

This second area of knowledge presents some unique concerns, especially for commercial UAS which tend to be designed with Commercial Off the Shelf (COTS) components, and have rapid development, deployment, and disposal cycles. Traditional aviation systems design process depends on very involved modeling, simulation, and flight test to define the operational limits of a given aircraft. While such techniques could be employed on UAS, it is quite possible that an individual UAS model has been designed, manufactured, fielded, and reached the end of its life cycle (the European Aviation Safety Agency built their Framework under the assumption that this could be as short as two years) before such work could be accomplished. Thus, an easier and faster way to assess the weather effects on flight characteristics—especially on flight safety—is needed.

Better Prediction at Fine Scale—A large factor in solid aviation decision making is the amount of data available to judge current weather conditions and the general accuracy and precision of the weather predictions. Less real time weather observation data to characterize the airspace, or less precision in the airspace weather predictions increases the uncertainty about what is currently and what will likely happen. This uncertainty either causes an operator to fly without a clear understanding of the risk, increasing the probability of an incident, or results in an overly conservative approach unnecessarily limiting flight operations.

The UAS Standards Collaborative (UASSC) 18-007, Preliminary Working Draft ANSI UAS SC Roadmap Version 1.0 identified gaps for UAS Operations and Weather as described below:
Gap O5: UAS Operations and Weather. No published or in-development standards have been identified that adequately fill the need for flight planning, forecasting, and operating UAS (including data link and cockpit/flight deck displays), particularly in low altitude and/or boundary layer airspace.

NUAIR, and a partnership with TruWeather Solutions and a consortium of universities, and commercial weather companies are working together to seriously address this critical gap that will inhibit the growth of the UAS industry without a better weather and decision-making solution. One objective is to determine the best mix of high-resolution observation measuring systems, science and machine-learning based models to improve micro weather detection and predictions and decision tools that translate wind components for UAS aircraft into specific impacts during flight operations.

High resolution modeling performed by TempoQuest Inc. is already demonstrating the benefits of high-resolution models at 1,000 meters in terrain. Below is a comparison of the National Weather Service High Resolution Rapid Refresh Model (HRRR) and TempoQuest AceCAST™ at 1,000 meters resolution computed on Graphics Processing Units (GPU). AceCAST™ in this case was downscaled from the same HRRR stimulation and captured channel winds in terrain that were washed out in the 3,000 meter simulation.

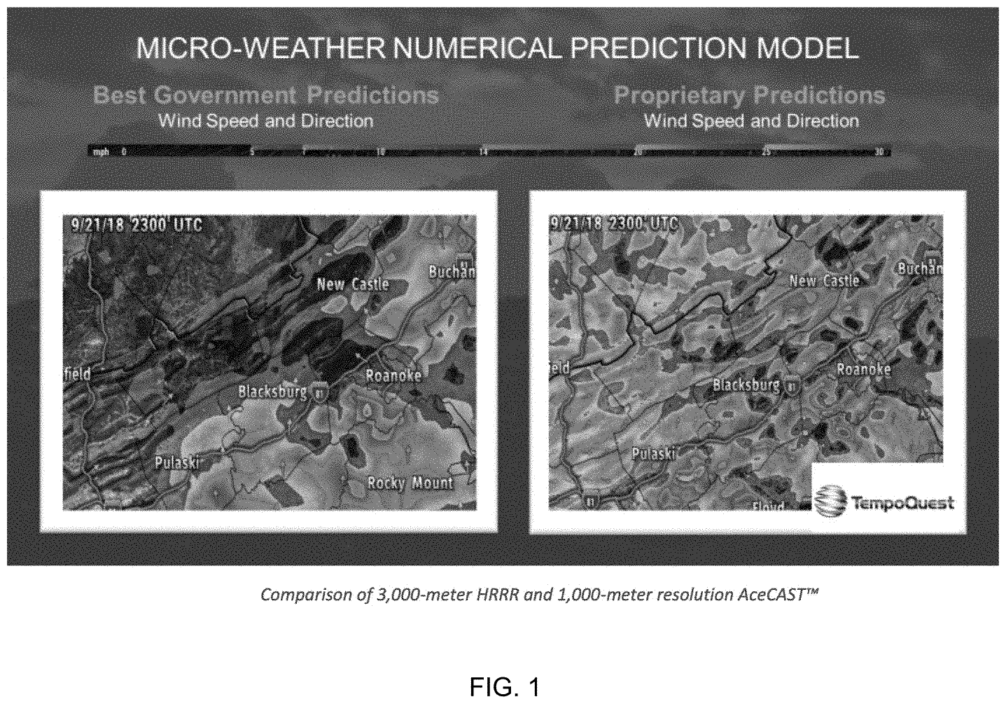

FIG. 1 is a drawing showing a comparison of 3,000-meter HRRR and 1,000-meter resolution AceCAST™.

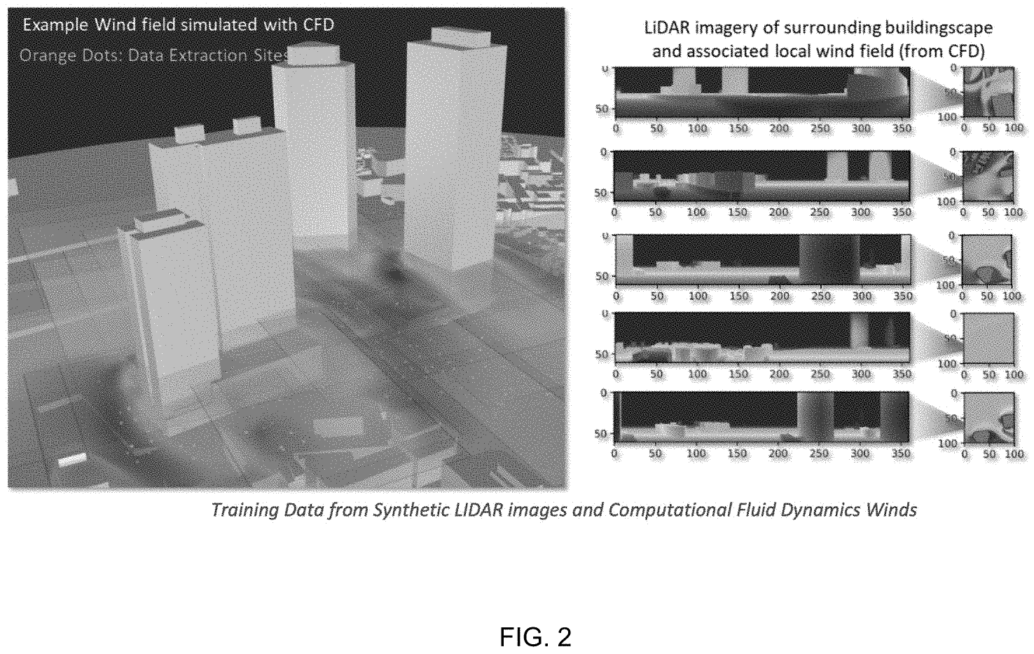

FIG. 2 is a drawing showing training data from Synthetic LIDAR images and Computational Fluid Dynamics Winds.

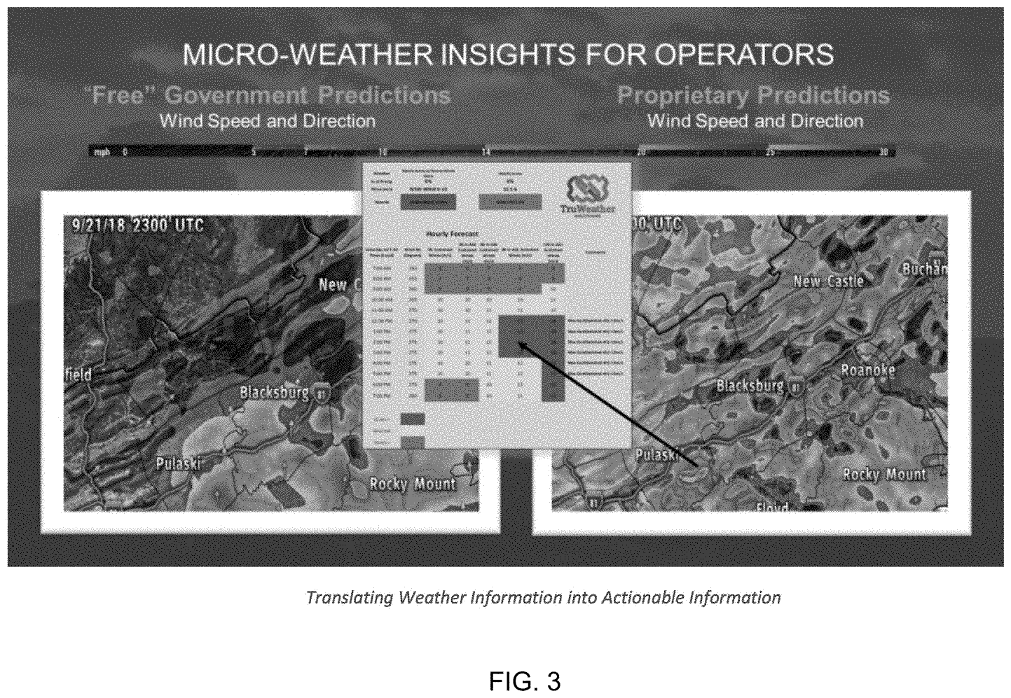

FIG. 3 is a drawing showing an exemplary translation of weather Information into actionable information.

The use of UAS in increasingly urban operations will require these small-scale effects be understood in the very complex environments of urban cityscapes. There are techniques under development to improve the characterization of wind and turbulent flow effects in urban terrain. Dr. John Melton (NASA Ames), leveraging a Machine Learning technique has a process designed to refine predictions using historical data sets and LIDAR imaged CityScape structures.

TruWeather, working with NUAIR is focused on building algorithms that translate weather data into actionable decisions for operators, including stoplight charts and flight route mission profiles. TruWeather intends to develop production strategies to operationalize the system for cloud services to unmanned traffic management (“UTM”) and automated traffic management (“ATM”) suppliers.

If the partnership group is successful at better characterizing terrain and cityscape obstacles to improve small wind and turbulent effect awareness, there is still a need to customize the output for impacts on specific airframes.

Assessing Impact on Flight Safety—As previously mentioned, the rapid development cycles and relatively short useful life span of individual UAS airframe models makes detailed flight characteristic databases difficult to create and maintain. Additionally, the fact that the control systems are so tightly coupled with many vehicles′, especially rotorcraft, flight characteristics, makes traditional wind tunnel testing difficult and the results hard to make relevant to the natural, open air environment. These characteristics combine to make the modeling, simulation, and flight test techniques traditionally used to define the operational limits of a given aircraft too slow to be able to respond appropriately. Thus, an easier and faster way to assess the weather effects on flight characteristics—especially on flight safety—is needed.

While traditional flight test evaluates air vehicles in their performance of a specific task, the spectrum of tasks which UAS are asked to perform is wide and ever varying. Thus, to tie ourselves to specific maneuvers at this stage in the evolution of UAS would be short sighted. Instead, we should define a new “task” that of maintaining course, speed, and orientation in the presence of disturbances, i.e. disturbance rejection, and specifically the control system's ability to reject disturbances. Clearly, aircraft limits may hamper disturbance rejection, i.e. hard to resist a headwind speed increase when already at top speed. But, understanding the influence weather has on this class of vehicles is imperative as we start to ascribe the performance requirements for the Unmanned Traffic Management (UTM) system.

The UTM concept is based on the idea that users of the system will share their intent amongst themselves and thus achieve a type of strategic deconfliction. As the size of the operational volumes reserved shrinks, the flight plan looks more and more like a four-dimensional trajectory (4DT) operation. The NextGen CONOPS describes 4DT as “ . . . a precise description of an aircraft path in time and space: the “centerline” of a path plus the position uncertainty, using waypoints to describe specific steps along the path.” Clearly, 4DT should have a sufficiently “tight”, or at least quantified, performance. UTM will evolve into essentially a trajectory based 4DT operation, so UA performance will need to be sufficiently well defined. The ease with which a pilot is able to precisely maintain a flight path is often referred to as “handling qualities”.

Handling Qualities when discussing unmanned systems are frequently (and almost universally) ignored. But, Cooper-Harper Rating (CHR) is based on the evaluation of performance and workload. Similarly, the tasks defined in this technique could be seen to reference performance, i.e. maintain course and speed within some bounds, and workload, e.g. power margin. Thus, we should be able to craft similar “levels” of CHR as in manned flight by properly defining “desired” and “adequate” performance for application in UTM performance requirements as well as acceptable workload in terms of power margin needed to assure acceptable flight safety.

In manned flight test, the division of missions into mission phases leads to precisely defined maneuvers, or Mission Task Elements (MTE). These MTEs are the tasks the test pilots must perform to assess the final Handling Qualities Ratings (HQRs). The workload encountered during the task, and the performance achieved, will define their Cooper-Harper rating.

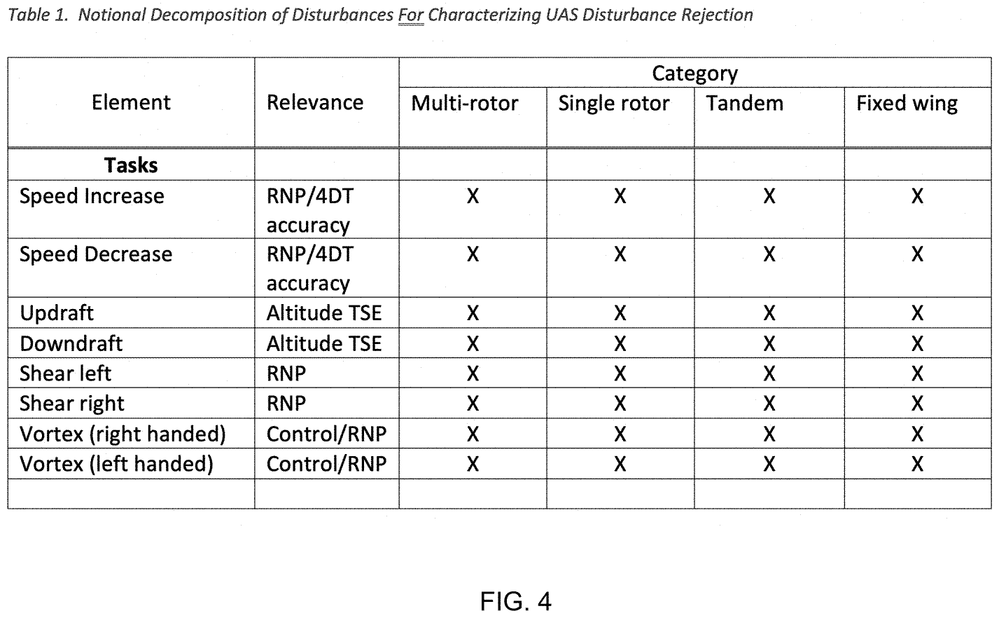

FIG. 4 is a table showing notional MTEs for UAS disturbance rejection.

Reproducing Drone Environment in a Laboratory

Fan Array Drone Test Facilities—WindShape facilities are based on the concept of wind-pixels (small diameter fans) and allow to generate variety of wind profiles. This wind tunnel technology is specifically designed for drone testing as it can generate small-scale wind effects, spatial variable wind profile, time variable winds and also directional winds.

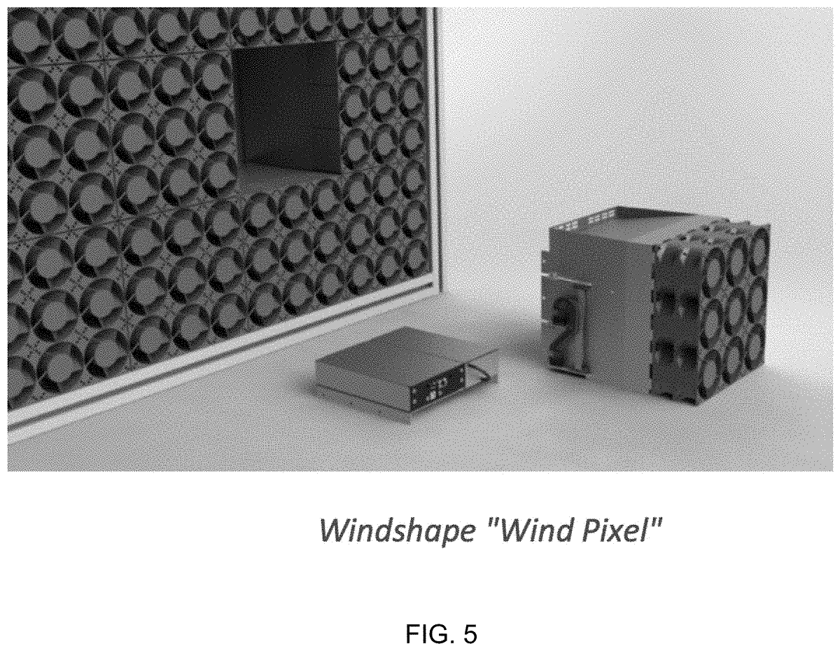

FIG. 5 is a drawing showing an exemplary Windshape “Wind Pixel”.

Generating the MTEs—Operators seeking operational approvals from their Civil Air Authority will have to go through specific test profiles with their vehicles in order to guarantee a certain level of safety in various wind and weather conditions (shear flows, gusts, rain, snow etc.).

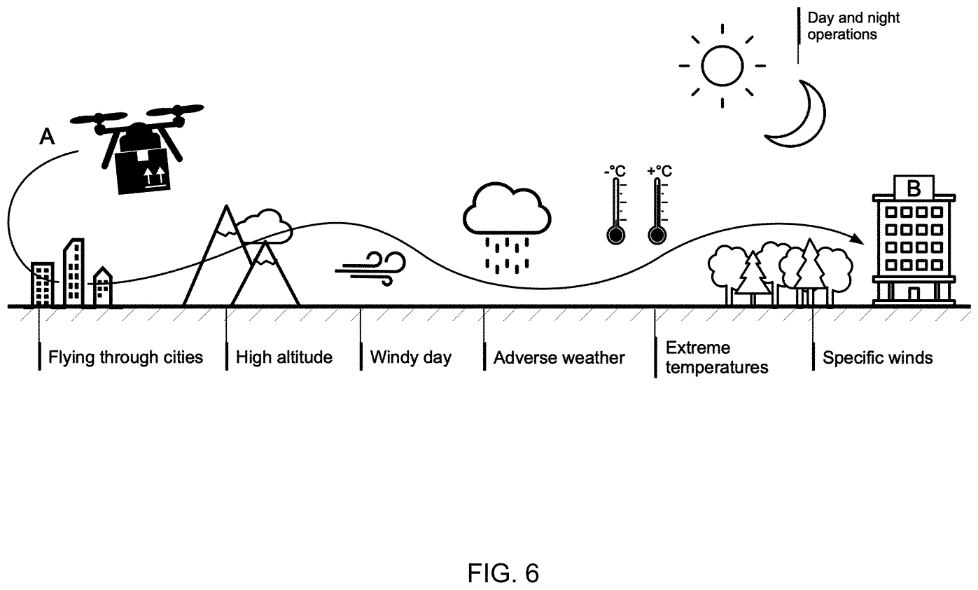

FIG. 6 is a drawings showing exemplary mission task elements (MTE).

Unfortunately, testing facilities (wind tunnels) that have been built in the past have been intended for traditional aircraft which, in general, either fly in relatively quiet atmospheric conditions or are so large and heavy that they are relatively unaffected by “turbulence” scales that are small relative to the size of the craft. Laminar, low turbulence tunnels are thus poorly representative of atmospheric conditions encountered by UAVs.

Due to the lack of testing solutions, UAV manufacturers have no choice other than going outside to test their flying vehicle. This testing methodology suffers from many drawbacks, including poor accuracy and repeatability, dependence on day-by-day weather and the weather forecast, unknown and non-controllable flow conditions, short test times, large distance between UAV and tester, etc.

In order to resolve the issues associated with traditional wind tunnels or outdoor testing protocols, real weather simulators are being developed for testing flying vehicles in various and controllable atmospheric conditions, including arbitrary wind speed and direction (even vertical flow for simulating landing/descent configurations), as well as turbulence, cross-winds, wind shear and, to some extent, hail, rain, snow etc.

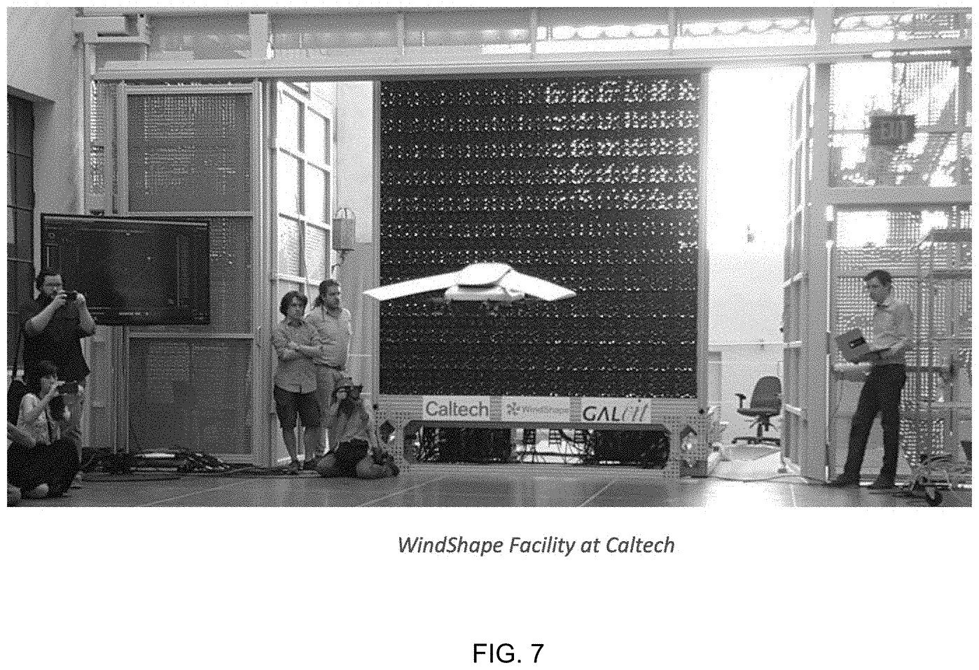

FIG. 7 is a drawings showing an exemplary WindShape facility at Caltech.

The novel wind facility allows free-flight maneuvering, is completely modular (FIG. 5), can be assembled in any desired geometry (FIG. 7), and can be made as large as desired while maintaining a small footprint. It is capable of generating gusts and arbitrary wind profiles (shear flows) in any direction. The product is now being commercialized by a Swiss company, WindShape (www.windshape.ch). The first such facility (FIG. 7) was purchased by the Aeronautics Department at the California Institute of Technology (Caltech) and inaugurated on Oct. 24, 2017, within its new Center for Autonomous Systems and Technologies (CAST, cast.caltech.edu).

Implementation of atmospheric wind conditions in Fan Arrays using Machine Learning—The WindShape equipment consists of surfaces of thousands of small diameter fans (wind pixels). These surfaces are commonly called fan-walls.

The question is: How should one program the wind pixel intensity and shape the fan-walls, in order to reproduce faithfully the atmospheric wind conditions in time and space within the volume of the test facility?

One methodology can be based on machine learning. Various geometrical fan-wall shapes can be setup with arbitrary wind pixel values (fan speed). For each wall setup and set of wind pixel values, experimental measurements of the flowfield can be collected within the volume. These experimental data can then be fed into a machine learning algorithm in order to train the WindShape facility. Ultimately, the facility will be able to generate arbitrary flow fields (in particular, real urban atmospheric turbulences) in time and space within the volume of the facility.

Examples of drone validation testing—WindShape multi-fan technology allows for a strong directional flow over very large distances (cf Caltech). One hundred feet is feasible with proper arrangement of the wall geometry (flow focusing).

In order to test wind draft resistance capability, the WindShape facility can be oriented according to needs, for instance it can be made to blow upwards in order to test drone resistance to updrafts. In the test laboratory, we are essentially moving the air relative to the aircraft versus moving the aircraft through the air.

Drone Testing Scenarios

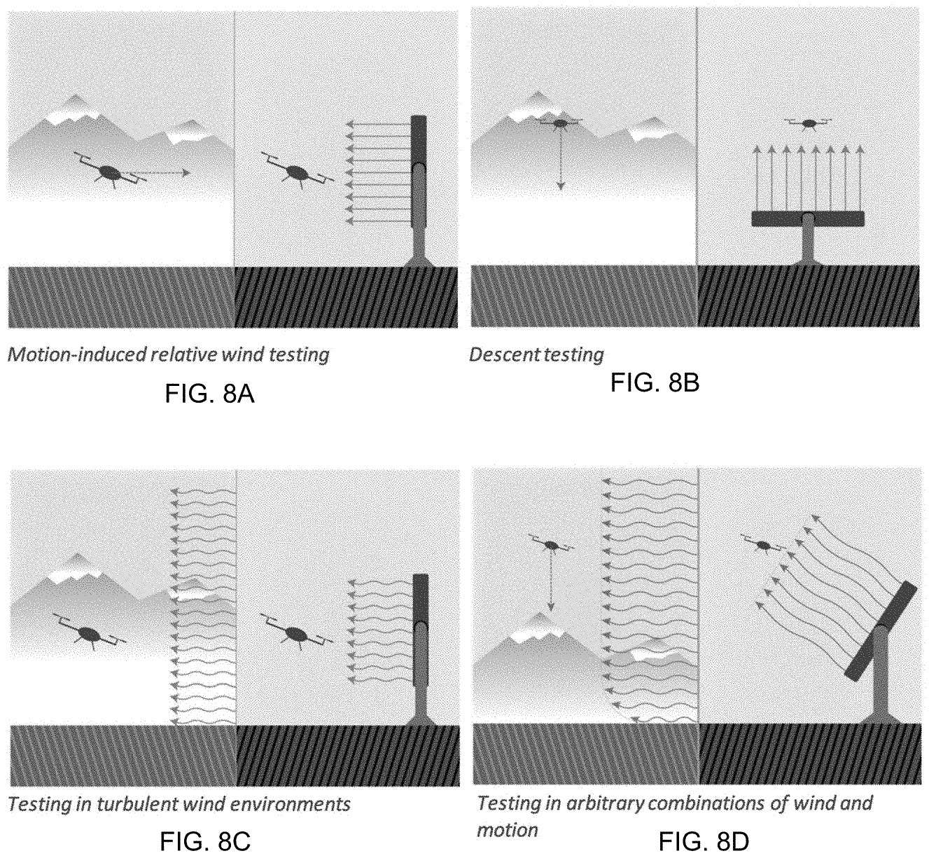

FIG. 8A to FIG. 8D show various drone testing scenarios. FIG. 8A is a drawing showing motion-induced relative wind testing. FIG. 8B is a drawing showing descent testing. FIG. 8C is a drawing showing testing in turbulent wind environments. FIG. 8D is a drawing showing testing in arbitrary combinations of wind and motion.

Steady scenario—A drone can be placed in the wind, and the wind intensity can be steadily increased until the drone fails to stay at a fixed point. This maximum draft velocity is a measure of the drone draft resistance. Beyond that point, the drift velocity is another measure of the drone draft resistance.

Gust (step) wind scenario—A drone can be inserted abruptly into a WindShape generated draft (with given flow velocity) or the draft velocity is raised very quickly (gust):

The drone is able to fight the draft—it is accelerated in the direction of the draft, then is able to decelerate to zero velocity and come back to the point of origin: the displacement of the drone is a measure of the drone resistance capability.

The drone is able to partially fight the draft—it is accelerated in the direction of the draft and is able to slow down to zero velocity (but is unable to come back to the point of origin): the drone displacement is a measure of the drone resistance capability.

The drone is unable to fight the draft—it is accelerated in the direction of the draft and is just able to slow down to a constant velocity along the draft: the distance where it reaches this minimum velocity is a measure of the drone resistance capability.

Periodic wind scenario—The drone will oscillate around a reference position: a draft resistance criterion may be that the drone stays within prescribed boundaries as a function of fluctuation frequency and amplitude.

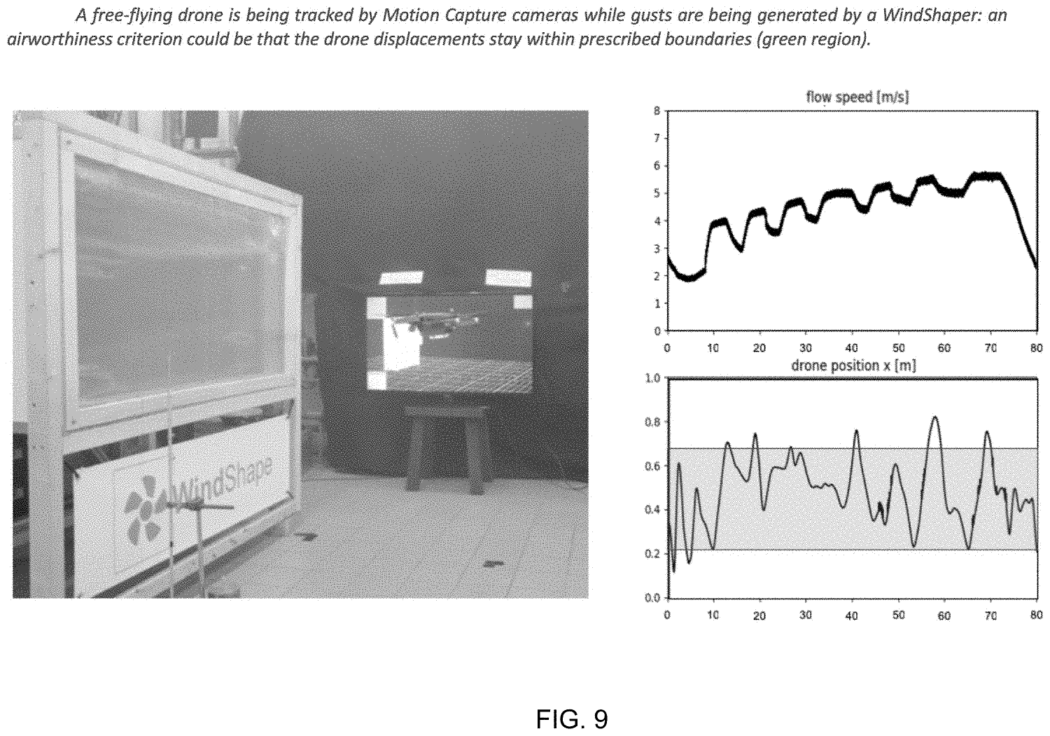

FIG. 9 is a drawing showing a free-flying drone tracked by motion capture cameras while gusts are being generated by a WindShaper with associated graphs. An airworthiness criterion could be that the drone displacements stay within prescribed boundaries.

Rain Testing Scenario—Drones will need to be validated in laboratory rain conditions before they can fly outdoor in equivalent conditions. Such validation procedures are needed for example to: control if a drone is waterproof while flying and that rain will not cause fatal short-circuit or electrical failure, validate that sensors are not affected by the presence of water, and to measure the effect of impacting drops that may represent a dangerous perturbation to small flyers.

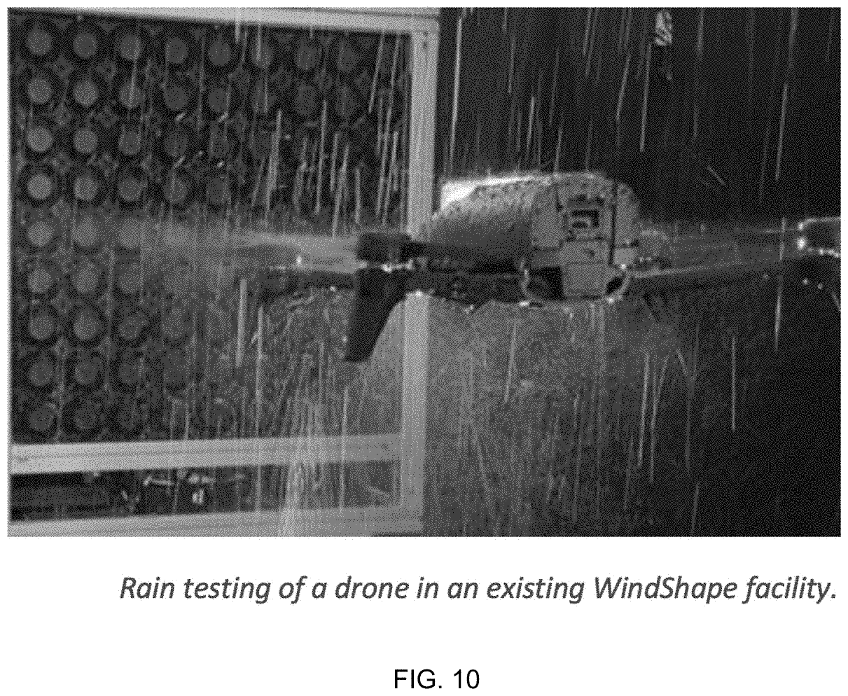

FIG. 10 is a drawing showing rain testing of a drone in an existing WindShape facility;

WindShape can include rain generators comprising a large number of drop injectors. The rain injectors have the ability to generate variable drop size ranging from 0.02 in to 0.2 in in diameter. The droplet flowrate is fully controllable in order to replicate a variety of real rain conditions. Finally, because drop speed at the moment of impact with the drone is considered as an important parameter, the ejection speed of drops at the injectors can also be controlled.

Low Temperature, Icing Conditions and Snow Testing Scenario—Preliminary tests have been performed at the Institute of Snow and Avalanches (SLF) in Davos, Switzerland. The SLF possesses five cold chambers. Each cold chamber operates at different temperatures in the range from −20 to 0 degrees Celsius. The cold chambers are up to 6 m×8 m in size which enabled us to set-up an existing reduced size fan array (1.5 m×0.75 m, 162 fans). Real (dendritic) snow can be produced in the cold chamber using the SLF “Snowmaker”. The preliminary test session revealed that a larger snow machine has to be designed to enable a long-period snowfall. This machine will allow to control the rate of the fall and the size of snowflakes. Together with high-speeds cameras it is possible to analyze the impact of snow and ice particles onto the drones. Typical tests can be: extract the preferred freezing sites on the drone, predict ice formation in icy conditions, characterize the effects of falling snow on the behavior of optical sensors, and to measure the weight repartition due to the accumulation of sticky snow on the drone.

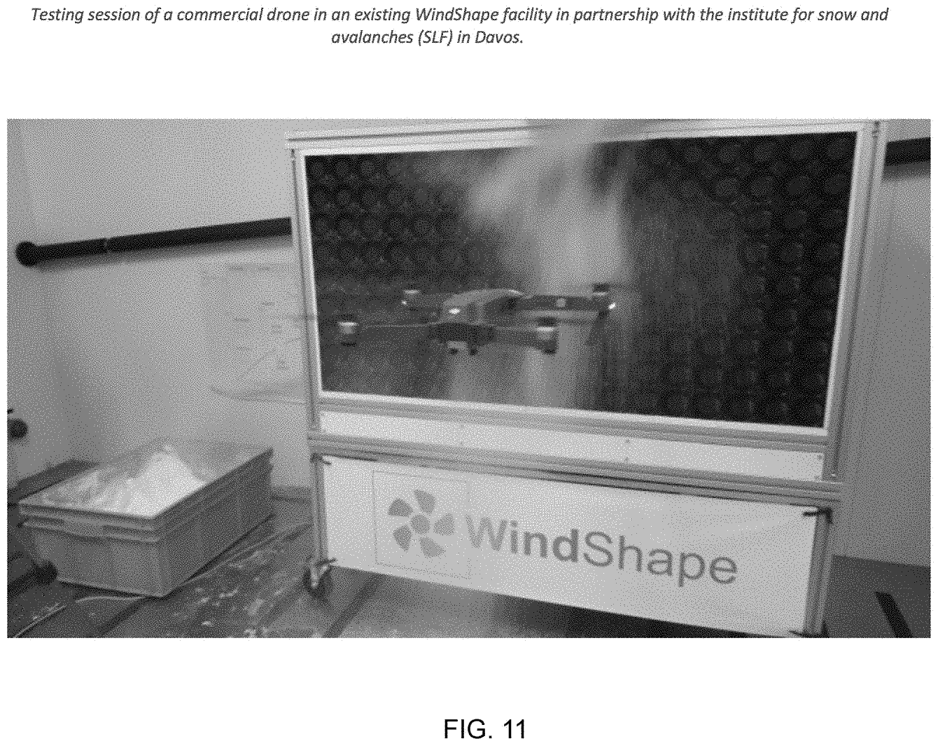

FIG. 11 is a drawing showing an exemplary testing session of a commercial drone in an existing WindShape facility in partnership with the institute for snow and avalanches (SLF) in Davos.

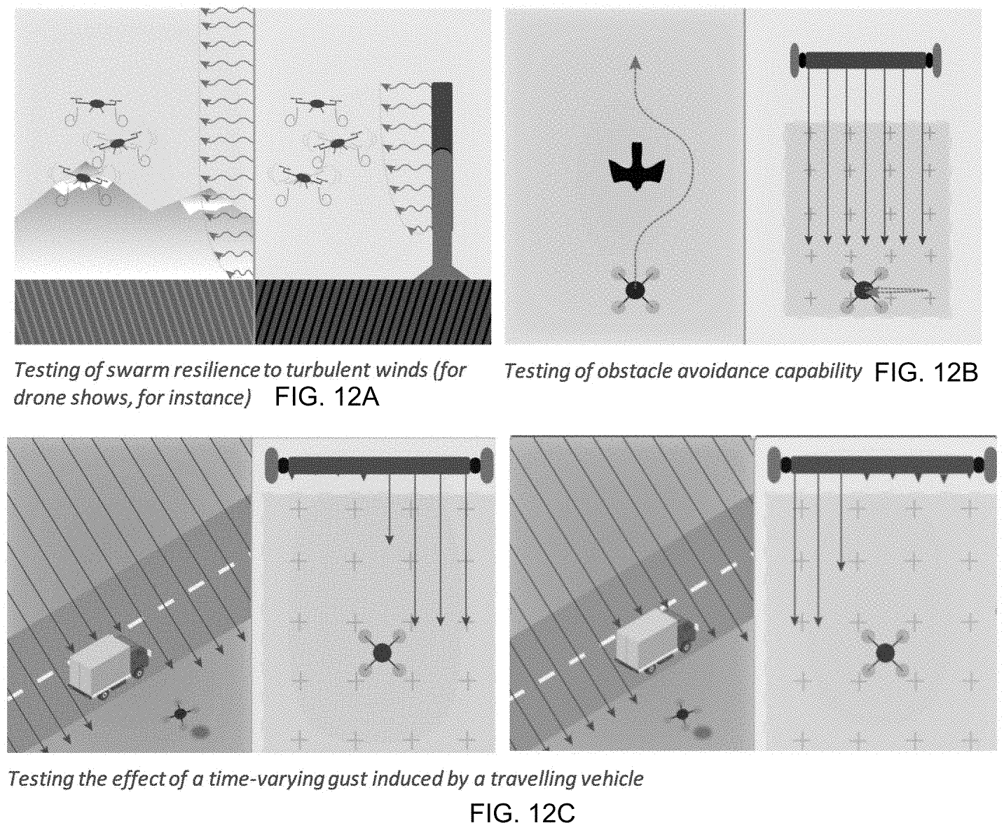

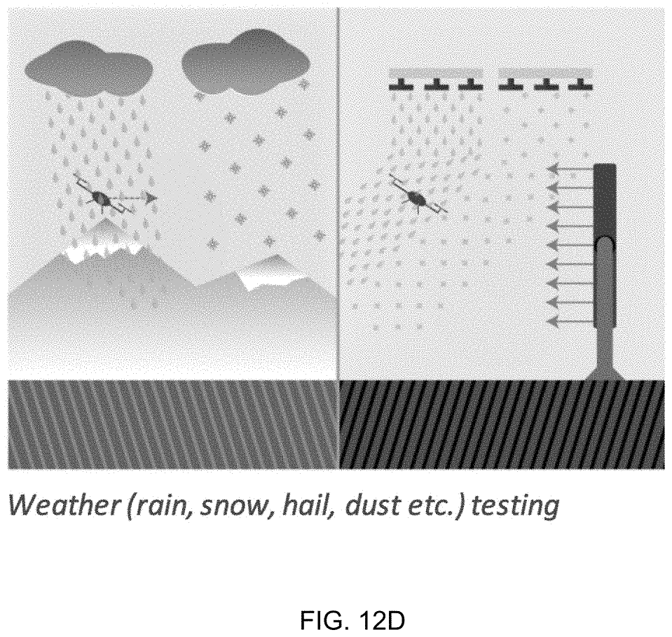

FIG. 12A to FIG. 12D show other exemplary situations that can be reproduced in the laboratory as test protocols. FIG. 12A is a drawing showing Testing of swarm resilience to turbulent winds (for drone shows, for instance). FIG. 12B is a drawing showing Testing of obstacle avoidance capability. FIG. 12C is a drawing showing Testing the effect of a time-varying gust induced by a travelling vehicle. FIG. 12D is a drawing showing Weather (rain, snow, hail, dust etc.) testing.

Capturing the behavior of drones during the laboratory tests—Motion tracking cameras can be used to precisely track in real-time drone position and attitude at a high frame rate (360 fps). From these measurements, one can get the speed and attitude of the drone during the flight test. Performance criteria can be setup thanks to this system, i.e. when facing a gusty wind profile, a drone shall stay in an acceptable range of position (move less that X meters).

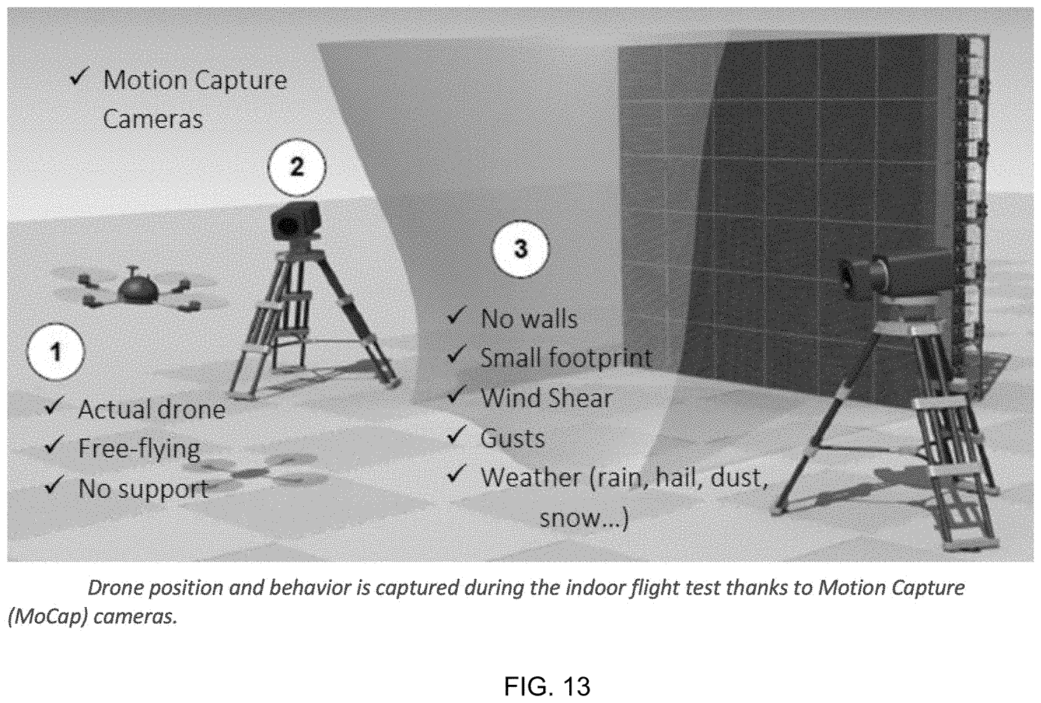

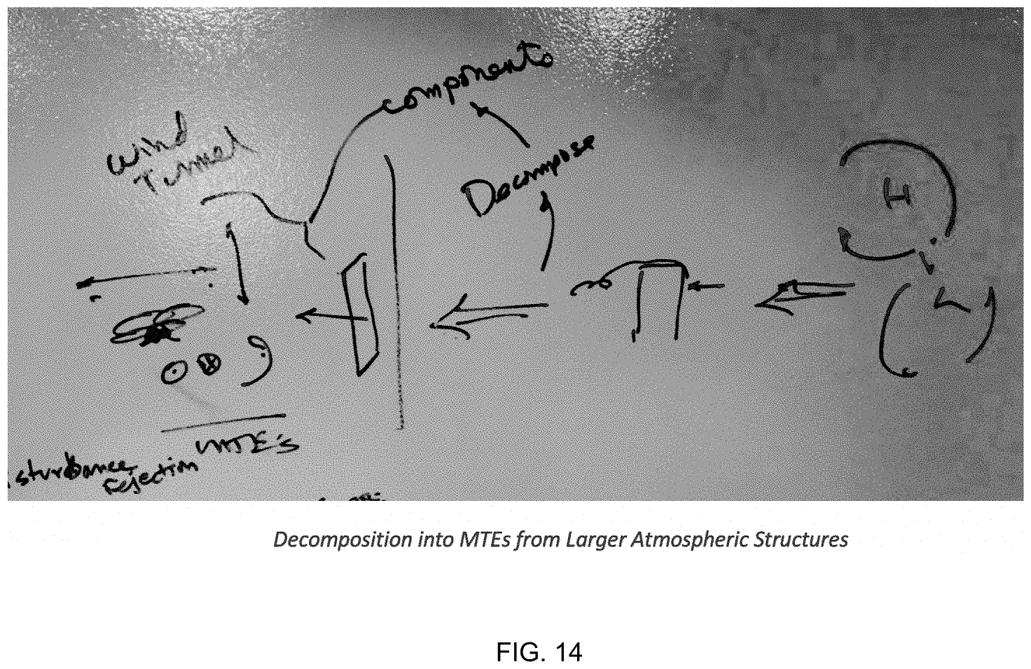

FIG. 13 is a drawing showing drone position and behavior captured during the indoor flight test using Motion Capture (MoCap) cameras. The air in these test spaces is moving relative to the aircraft vice moving the aircraft through the air.

FIG. 14 is a drawing showing an exemplary decomposition into MTEs from Larger Atmospheric Structures. Starting from right to left, FIG. 14 shows large scale atmospheric systems captured in global numerical weather prediction models, then downscaled, potentially improved with higher resolution observational data sets and evaluated in higher resolution modelling which produce micro-scale wind and weather predictions. These wind predictions leverage precise, geographically represented terrain models to produce hyper-local estimates of turbulence and vorticity which can be assigned a Turbulence Descriptor (TD) rating. A geo-referenced “heatmap” of TD rating can then be used in flight planning such that UAs with small TD ratings are only flight planned through low TD areas. Clearly, there is an incentive for manufacturers to design aircraft robust to large TDs.

Initial assignment of the TD ratings is accomplished by decomposing the components of turbulence and vorticity into the components introduced in FIG. 4, Table 1. The strength of a disturbance can be graduated and thus define a TD level classification scale.

“Desired” and “Adequate” performance are then defined as appropriate to the requirements of the airspace in which the UA is intended for operation. Two power margin thresholds are established in terms of percent remaining such that we can define a rough equivalent to “Level 1” HQR, i.e. desired performance achievable with “sufficient” power margin. And a “Level 2” HQR, i.e. achieving adequate performance leaves “minimal” power margin. Not meeting adequate performance with a minimum power margin is classified as “Level 3” and would be a “Fail” in this test definition in that the UA in question would not be allowed to fly into weather described by the TD level under test, and thus would be allowed only in conditions of lower TD.

Based on the UA rating in each of the MTEs, an overall TD rating can be assigned to that UA configuration.

It was realized that beyond the component of a wind tunnel having disposed within a flyable airspace for a UAS, for testing in fully autonomous test flight regimes, there is a need for a GPS simulator capable of fooling UAS systems into thinking they are flying along the prescribed flight path. This will be particularly important for aircraft flying as fixed wing where it is impossible to maintain flight without a nominal flow field. There is also a need for a way to extrapolate measurements of the vehicle's initial response to the disturbance in the test facility to that which could be expected in the open air—unconstrained by the test cell size. For example, a vertical updraft sufficiently large to displace a vehicle on the order of 100 feet will be difficult to replicate in the test facility. However, the evaluation of a UA's resistance to such disturbances is necessary.

It was also realized that a GPS simulator can be combined with wind tunnel testing of UAS. By sending a simulated GPS signal to a UAS under test, the UAS flies “normally” and “normally autonomously” in the conditions of the flyable airspace of the wind tunnel, over a simulated moving ground below according to its own onboard GPS receiver.

As described hereinabove, one of the goals of wind tunnel testing is to simulate micro weather conditions which can be disruptive to a UAS. In support of such testing and studies, a flyable airspace of a wind tunnel environment should be able to present many types of relevant disruptions to the flight of the UAS, such as, for example, disruptions to roll, pitch, and yaw caused by turbulence, such as, for example, wind gusts, and/or wind voracity. However, the GPS solutions of the GPS simulator signals at the on board UAS GPS receiver should continue to reliably converge, despite the relatively fast time scale disturbance to the UAS which causes disruptions to the UAS flight path. That is, the intended disruptions during wind tunnel testing, such as to test operation within or to define a safe operating envelope for one or more flight parameters cause the UAS to physically deviate from the basis flight path (typically one or more straight lines of any suitable vector direction in a three-dimensional airspace) simulated by the GPS simulator.

Harmonization Solution of the Application

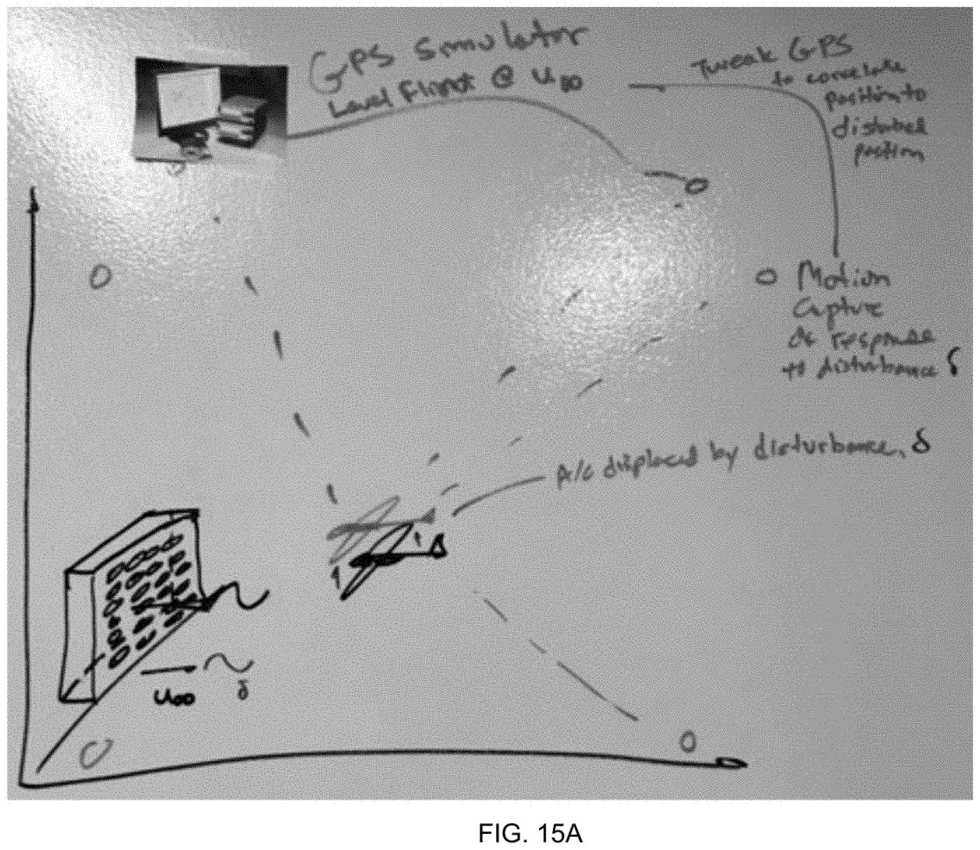

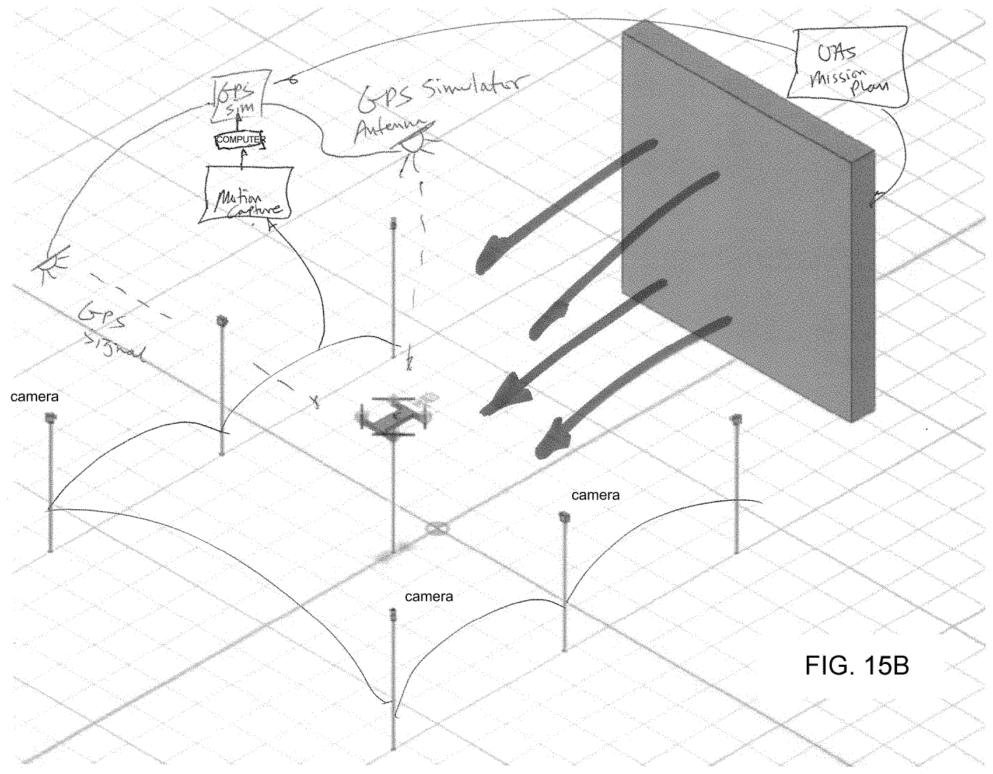

FIG. 15A to FIG. 15B show system drawings according to the new system and method of the Application. FIG. 15A is a drawing showing a system according to the application. FIG. 15B is another drawing showing a system according to the application.

To accurately fly a UAS in a wind tunnel by use of GPS simulation, what is needed is a harmonization between the real-time UAS actual position (location) and the GPS simulator, so that the GPS simulator continues to send accurate position information to the UAS indicative of the intentional short-term disruptions to UAS flight caused by fast change in the simulated wind flow within the wind tunnel. Otherwise, even though the UAS has actually deviated from the typical straight line of the basic GPS simulation from point A to point B, the UAS onboard GPS navigation receiver will still indicate that the UAS under test is still exactly on the point A to point B flight path with no indicated deviation (despite an actual deviation from the simulated straight line flight plan of the GPS simulation).

However, the UAS actual physical position in the wind tunnel can be known substantially in real time, by any suitable measuring or monitoring means, such as, for example, an optical monitoring of reference points at various physical locations on different parts of the UAS.

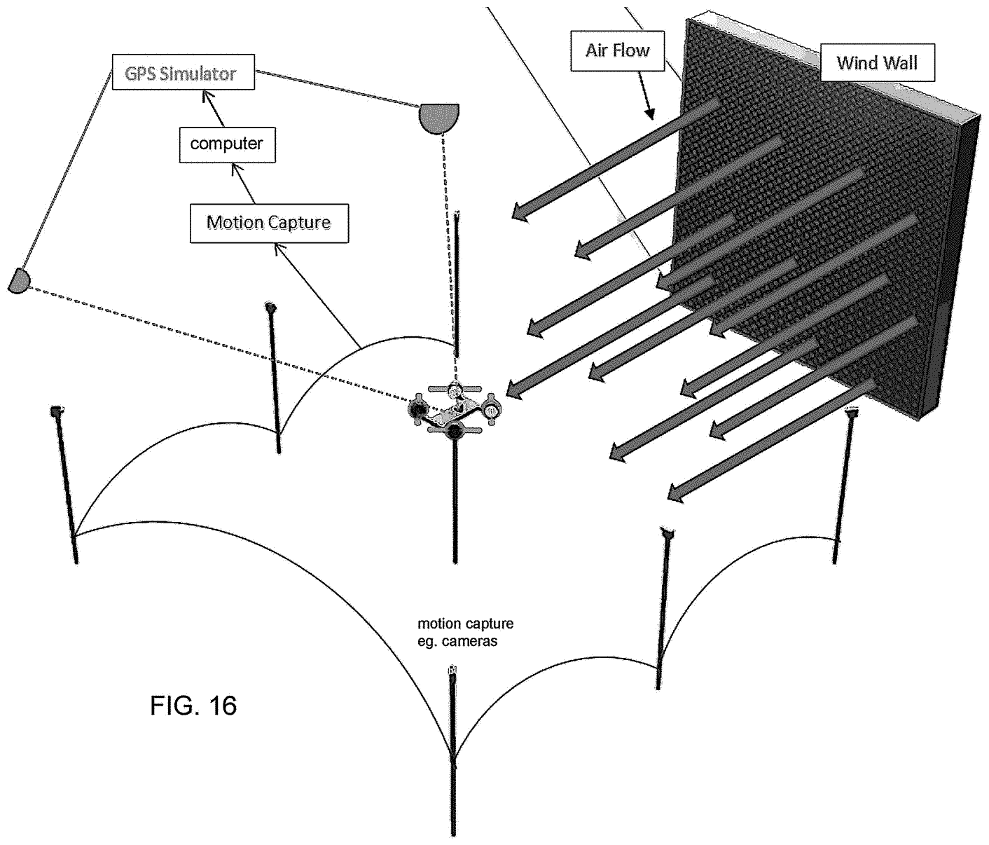

FIG. 16 is a drawing showing an exemplary camera placement. Location processes can be run based one or more camera video streams from one or more locations at the wind tunnel which can view the reference points of the UAS. Typical reference points include optical reflectors or lights placed at the UAS physical reference points. Other systems may include any suitable range measurements to reflective points on a UAS under test. Suitable range finding methods and techniques include, for example, video, sequential still images, radio, sonar, radar, lidar, audio, radio range, audio range, ultrasonic range, laser range finding, etc.

An actual position solution of the new harmonization system and method of the Application solves the problems with conventional GPS simulation. It was realized that real time data, of the actual position of the UAS in the wind tunnel can be operatively coupled to the GPS simulator, to correct the simulated advancing path over the ground for the substantially real time position of the UAS in the flyable airspace of the wind tunnel. That way, the onboard GPS receiver receives a simulated GPS signal which is “true” to the actual position of the UAS in the flyable airspace of the wind tunnel, preferably on time scales as fast or faster than the UAS GPS receiver can calculate navigation solutions.

In other words, flying a UAS from point A to point B by GPS simulation in a wind tunnel (or any other suitable physically restrained flyable testing airspace) alone is not sufficient to explore the various parameters of UAS autonomous flight. The reason is that the while the UAS longer term would be moving from point A towards point B, the physical structure of the UAS actually moves off that path during each intended flight path disruption, however the on board UAS GPS would not reflect the short-term motions because the on-board GPS is only solving for the simulated GPS simulation. That is, while internal UAS flight responses to onboard accelerometers or flight gyros remain active, the short-term response of input to the UAS autonomous flight by the UAS onboard GPS, without corrections to the simulated GPS signal as described hereinabove, goes otherwise completely untested in this relatively simple point A to point B GPS simulation.

What is needed is a new system and method to fly a fully production representative UAS test article operating “no strings (or wires) attached” in a flyable airspace, such as a flyable airspace of a wind tunnel, where a true reaction of the system to various internal and external stimulus can be captured as produced.

It was realized that by coupling the actual measured position of the UAS in the wind tunnel at any given time (substantially in real-time) and operatively coupling that position to the GPS simulator, the UAS onboard GPS can now be made to receive a simulated “actual” position indicative of the actual physical position of the UAS in the flyable airspace of the wind tunnel space. In other words, once the GPS simulated signal is harmonized with the actual position of the UAS in the wind tunnel, the UAS can now be fully tested in its autonomous flying modes where the onboard GPS calculated position and motion solutions (e.g. accelerometers and/or gyros) are now fully engaged to autonomously control the UAS flight control system. It was further realized that, only under such conditions of GPS harmonization with actual UAS under test position in the wind tunnel can a UAS be realistically tested for real-world autonomous flight controlled in part by the UAS onboard GPS.

System Resources—Any suitable GPS simulator capable of “fooling” the system into thinking the UAS is flying along the prescribed flight path can be used. This is helpful for aircraft flying as fixed wing where it is difficult to maintain flight without a nominal flow field. Because the aircraft will be disturbed by, for example, a gust, the motion capture system should be able to adjust, or “tweak”, the GPS simulated position and speeds such that the onboard guidance systems are exposed to as “correlated” an environment as possible. Said another way, if the onboard flight control system feels an acceleration upward in response to a gust, the GPS simulated location should also translate appropriately. This is accomplished by “tweaking” the GPS location with the displacement measured by the motion capture system.

There should also be a way to extrapolate measurements of a vehicle's initial response to a disturbance in the test facility to that which could be expected in the open air—unconstrained by the test cell size. For example, a vertical updraft sufficiently large to displace a vehicle on the order of 100 feet will be difficult to replicate in existing test facilities having physical vertical heights of less than 100 feet. However, the evaluation of a UA's resistance to such disturbances is necessary. We can to evaluate what is a notional 4DT tracking accuracy requirement, i.e. how much larger than the test area, in the proof of concept phase. There might be potential for using repeatable and characterizable disturbances and measured responses to extract and correlate a model (even a set of very simple, generic 2DOF or 3DOF models) and then look at that models (linear) response to larger inputs. One method could be to do a simple system identification of a prescribed linear model for each given class of aircraft, then use those models to establish high-amplitude disturbance responses. This suggests Tischler's ‘Control Equivalent Turbulence Inputs” technique but with a fully characterized turbulence environment to establish a linear model and extend it to larger disturbances.

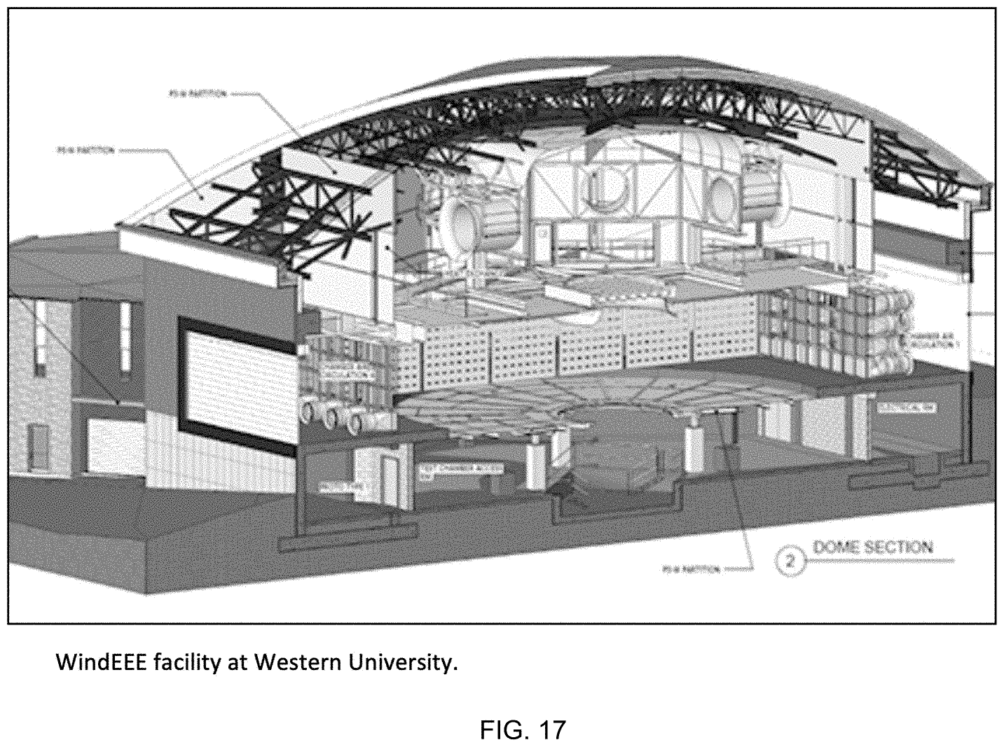

WindEEE facility—WindEEE is the world's first test chamber that specialized in 3D flow simulations at very large scale and hence a nice complement to Windshape. The WindEEE dome has a unique capability to produce a wide variety of tridimensional flows at specific scales and resolutions, including tornados, downbursts, wind shears/gradients, low level currents and gust fronts and Atmospheric boundary layers. WindEEE has a 1.8 MW power draw and is configured with a 5 m lift and turntable, 106 individually controlled fans, 1600 floor roughness elements, 5 m diameter storm systems and 1.5 m/s windstorm translation. FIG. 17 is a drawing showing a cut-out view of the a WindEEE facility at Western University.

The increased use of UAVs in ever more demanding applications adds a new layer of complexity in UAV engineering. The WindEEE facility provides cutting-edge research opportunities including simulation of special 3D flows specific to UAV applications (e.g. industrial maintenance, mining, surveillance, entertainment). measurements of UAV-produced flows and their effect on payload and surrounding environment, and controller and payload monitoring under custom in-flight scenarios.

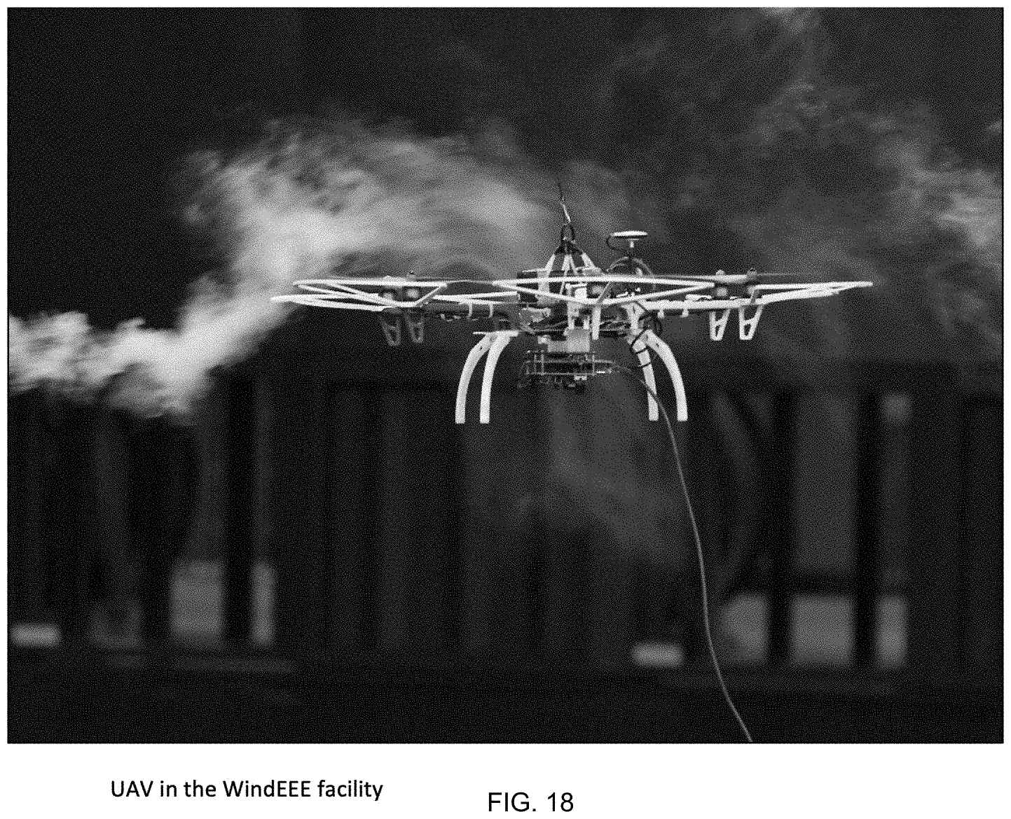

FIG. 18 is a drawing showing a UAV in the WindEEE facility

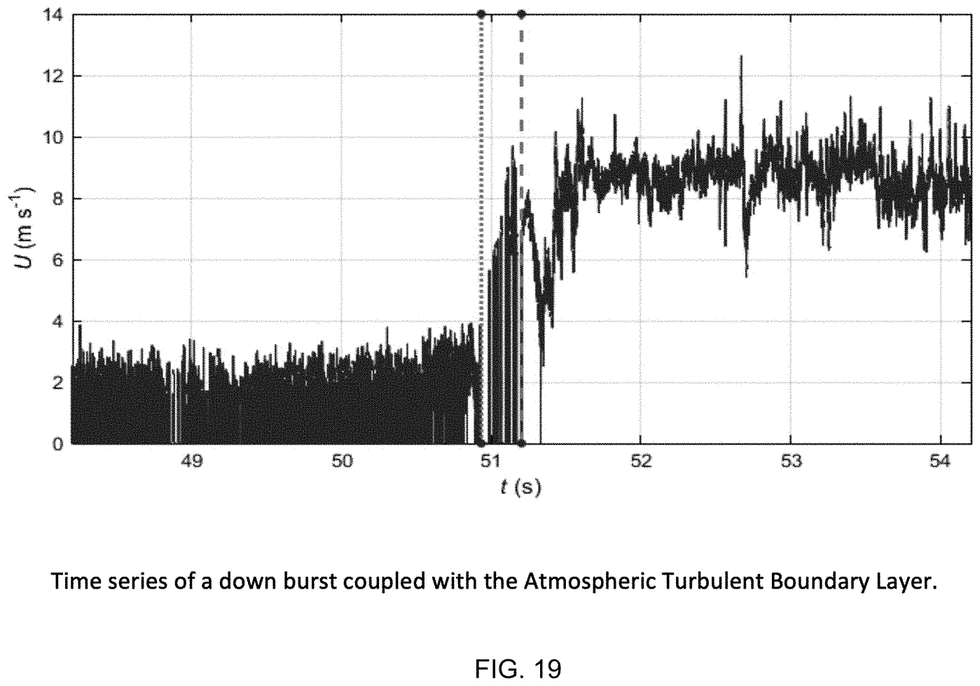

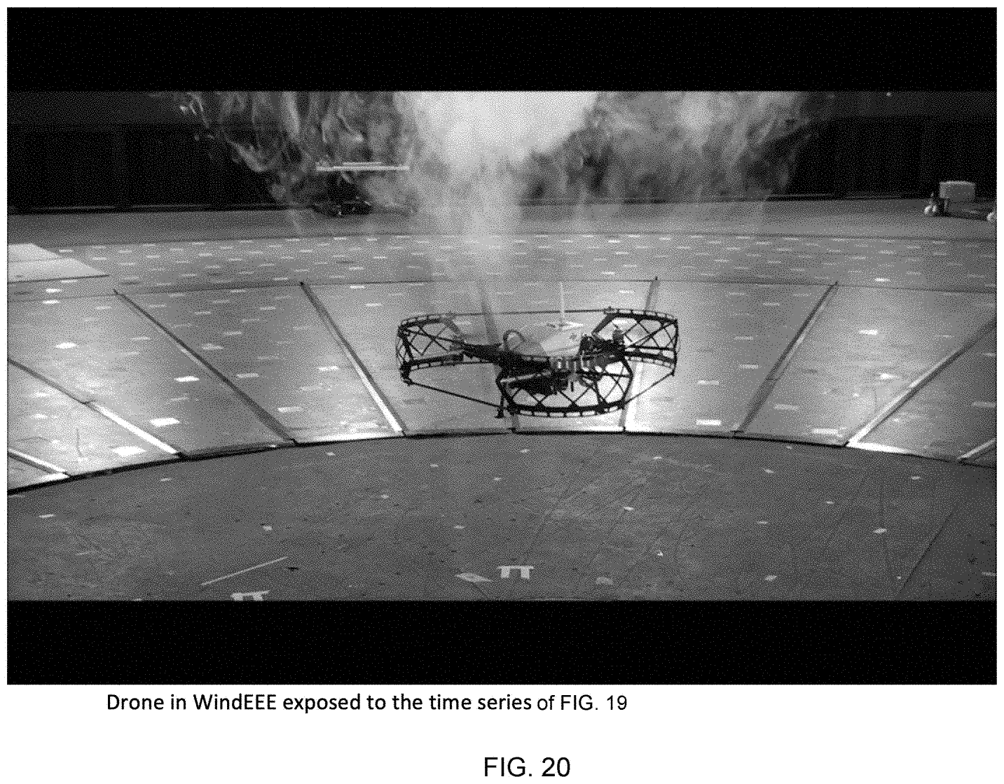

FIG. 19 is a graph showing a time series of a down burst coupled with the Atmospheric Turbulent Boundary Layer. FIG. 20 is a drawing showing a drone being exposed to the wind time series of FIG. 19.

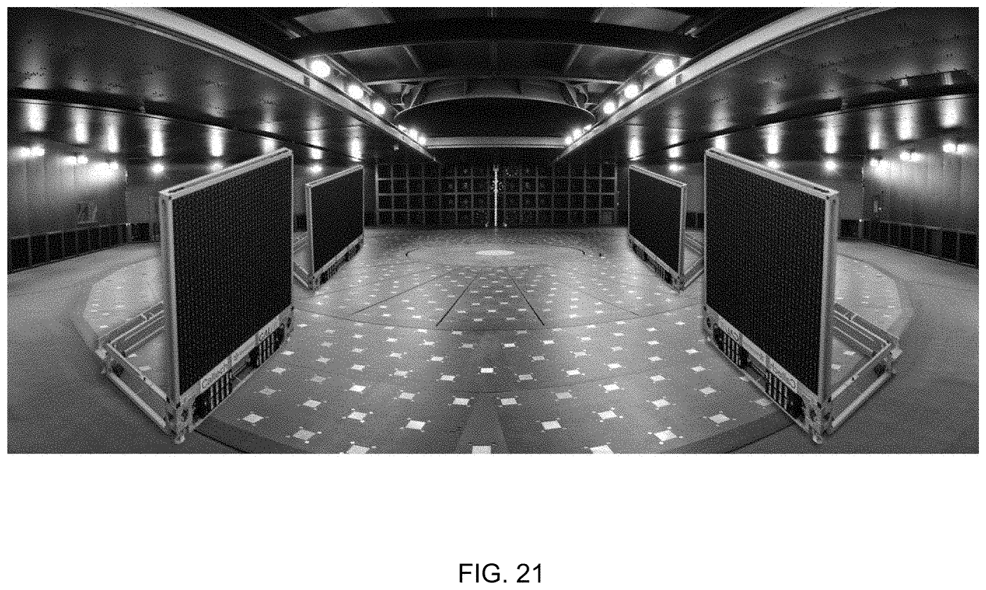

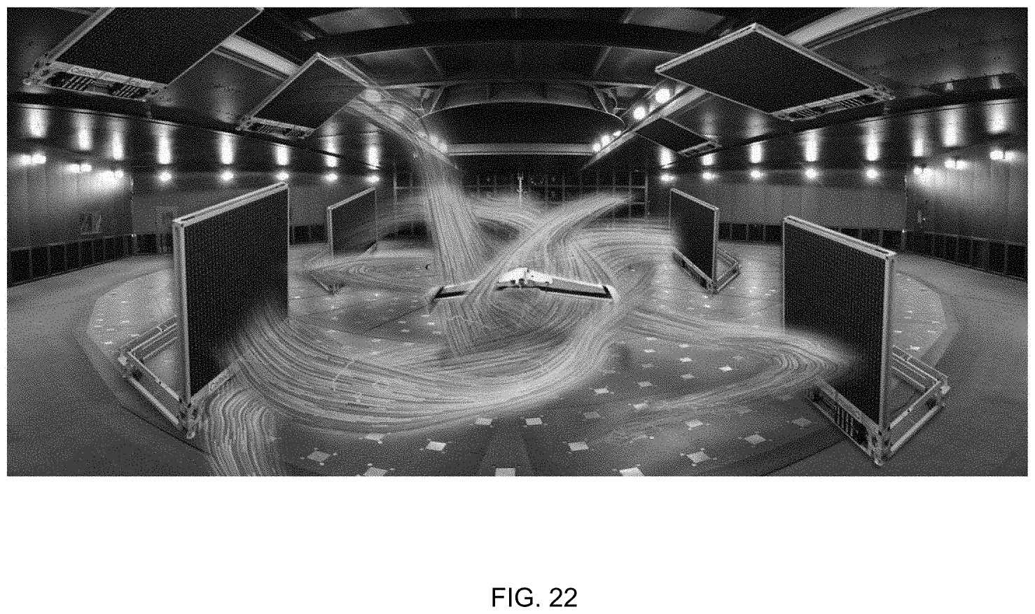

FIG. 21 is a drawing showing an exemplary positioning of WindShape elements in a WindEEE facility. A WindEEE facility can be augmented with Windshape elements sufficient to create the various elements of the disturbance MTE discussed above. FIG. 22 is a drawing showing how an airflow from the WindEEE wind tunnel can create the “steady state” flow necessary to keep fixed wing aircraft airborne within the test section while Windshape elements can supplement the flow pattern to produce the desired disturbance component.

### SUMMARY

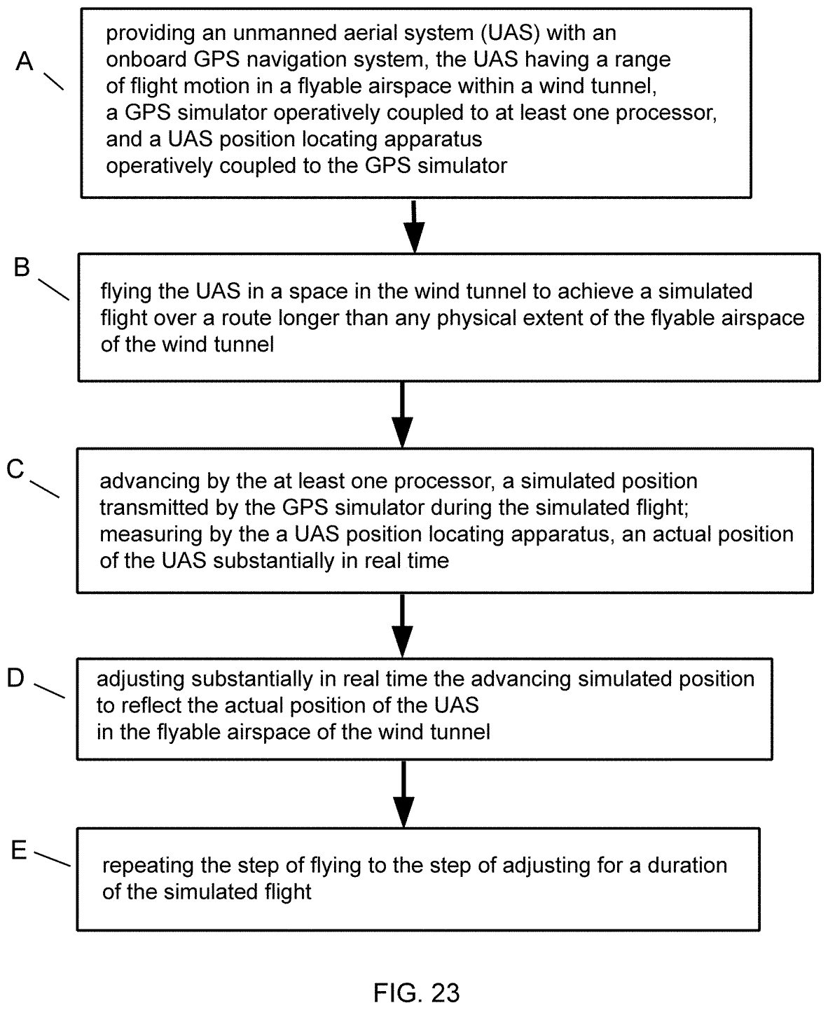

FIG. 23 is a flow diagram showing an exemplary method according to the application. A method for testing a UAS in a fully autonomous operating mode includes: A) providing an unmanned aerial system (UAS) with an onboard GPS navigation system, the UAS having a range of flight motion in a flyable airspace within a wind tunnel, a GPS simulator operatively coupled to at least one processor, and a UAS position locating apparatus operatively coupled to the GPS simulator; B) flying the UAS in a space in the wind tunnel to achieve a simulated flight over a route longer than any physical extent of the flyable airspace of the wind tunnel; C) advancing by the at least one processor, a simulated position transmitted by the GPS simulator during the simulated flight; measuring by the a UAS position locating apparatus, an actual position of the UAS substantially in real time; D) adjusting substantially in real time the advancing simulated position to reflect the actual position of the UAS in the flyable airspace of the wind tunnel; and E) repeating the step of flying to the step of adjusting for a duration of the simulated flight.

Also, as shown in FIG. 15B, a system for testing a UAS in a fully autonomous operating mode includes a wind tunnel having a flyable airspace disposed within. The wind tunnel is adapted for a flight of an unmanned aerial system (UAS) with an onboard GPS navigation system. The UAS has a range of flight motion in the flyable airspace within the wind tunnel. A GPS simulator is operatively coupled to at least one processor. A UAS position locating apparatus to determine the actual position of the UAS in the flyable airspace is operatively coupled to the GPS simulator.

At least one processor—Typically, the new method described hereinabove can be executed on a computer having disposed within, the at least one processor. In the drawings, sometimes there is shown a separate computer and a motion capture box. While there can be any suitable motion capture technology used, or combinations thereof, it is unimportant whether the initial motion capture data is processed on a separate motion capture computer or on the computer which includes the at least one processor. There will be present at least one processor, typically the processor a computer, however it unimportant what form the at least one process takes, ranging from, for example, a dedicated embedded processor to any suitable computer such as a work station, desktop computer, mobile computer, etc.

Software and/or firmware for the system and method described hereinabove can be supplied on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for testing a UAS in a fully autonomous operating mode comprising:
providing an unmanned aerial system (UAS) with an onboard GPS navigation system, the UAS having a range of flight motion in a flyable airspace within a wind tunnel, a GPS simulator operatively coupled to at least one processor, and a UAS position locating apparatus operatively coupled to said GPS simulator;
flying said UAS in a space in said wind tunnel to achieve a simulated flight over a route longer than any physical extent of the flyable airspace of the wind tunnel;
advancing by said at least one processor, a simulated position transmitted by said GPS simulator during said simulated flight;
measuring by said UAS position locating apparatus, an actual position of said UAS substantially in real time;
adjusting substantially in real time said advancing simulated position to reflect the actual position of said UAS in the flyable airspace of the wind tunnel; and
repeating said step of flying to said step of adjusting for a duration of the simulated flight.

2. The method of claim 1, wherein said step of flying comprises a perturbation within the flyable airspace of the wind tunnel causes the actual position of said UAS to deviate from a simulated position based on time of flight.

3. The method of claim 2, wherein said perturbation caused by an intentional upset to an airflow within the wind tunnel.

4. The method of claim 3, wherein said intentional upset to the airflow within the wind tunnel comprises a simulated wind gust.

5. The method of claim 4, wherein said simulated wind gust comprises an updraft or a downdraft.

6. The method of claim 4, wherein said simulated wind gust comprises a microburst.

7. The method of claim 4, wherein said simulated wind gust comprises a vorticity.

8. The method of claim 2, wherein said perturbation is caused by an intentional upset command to a flight control of said UAS.

9. The method of claim 8, wherein said perturbation comprises an upset in roll or pitch of said UAS.

10. The method of claim 8, wherein said perturbation comprises an upset in yaw of said UAS.

11. The method of claim 2, wherein said perturbation comprises an upset in at least one power plant motor or engine.

12. The method of claim 2, wherein perturbation comprises an upset in at least one propeller or fan.

13. A system for testing a UAS in a fully autonomous operating mode comprising:
a wind tunnel having a flyable airspace disposed within adapted for a flight of an unmanned aerial system (UAS) with an onboard GPS navigation system, the UAS having a range of flight motion in the flyable airspace within said wind tunnel;
a GPS simulator operatively coupled to at least one processor; and
a UAS position locating apparatus to determine the actual position of the UAS in the flyable airspace operatively coupled to the GPS simulator.

14. A method for testing a UAS in a fully autonomous operating mode comprising:
providing an unmanned aerial system (UAS) with an onboard navigation system, the UAS having a range of flight motion in a flyable airspace within a wind tunnel, a navigation simulator operatively coupled to at least one processor, and a UAS position locating apparatus operatively coupled to said navigation simulator;
flying said UAS in a space in said wind tunnel to achieve a simulated flight over a route longer than any physical extent of the flyable airspace of the wind tunnel;
advancing by said at least one processor, a simulated position transmitted by said navigation simulator during said simulated flight;
measuring by said a UAS position locating apparatus, an actual position of said UAS substantially in real time;
adjusting substantially in real time said advancing simulated position to reflect the actual position of said UAS in the flyable airspace of the wind tunnel; and
repeating said step of flying to said step of adjusting for a duration of the simulated flight.

15. The method of claim 14, wherein said navigation system comprises a GPS navigation system and said navigation simulator comprises a GPS simulator.
